(19) United States
(12) Patent Application Publication
(10) Pub. No.: US 2021/0291173 A1
(43) Pub. Date: Sep. 23, 2021

(54) PATTERNED MICROFLUIDIC DEVICES AND METHODS FOR MANUFACTURING THE SAME

(71) Applicant: CORNING INCORPORATED, CORNING, NY (US)

(72) Inventors: Ye Fang, Painted Post, NY (US); Joydeep Lahiri, Corning, NY (US); Georges Roussos, San Jose, CA (US); Paul Michael Then, Victor, NY (US)

(21) Appl. No.: 17/266,242

(22) PCT Filed: Jul. 30, 2019
(86) PCT No.: PCT/US2019/044011

§ 371 Date: Feb. 5, 2021

Related U.S. Application Data
(60) Provisional application No. 62/714,983, filed on Aug. 6, 2018.

(51) Int. Cl. B01L 3/00

(52) U.S. Cl. CPC B01L 3/502707; B01L 2300/12; B01L 2200/021; B01L 2300/0877; B01L 2200/12; B01L 2300/123; B01L 2300/16; B01L 2300/168; B01L 2300/0893

(57) ABSTRACT

A microfluidic device includes a first substrate comprising a surface, a flow channel disposed in the first substrate such that a sidewall of the flow channel extends between a floor of the flow channel and the surface, a film disposed on the floor of the flow channel, an array of wells disposed in the film, and a second substrate bonded to the surface of the first substrate, whereby the second substrate at least partially covers the flow channel.

### CROSS-REFERENCE TO RELATED APPLICATIONS

This application claims the benefit of priority under 35 U.S.C. § 119 of U.S. Provisional Application No. 62/714,983, filed Aug. 6, 2018, the content of which is incorporated herein by reference in its entirety.

### BACKGROUND

### 1. Field

This disclosure relates to patterned microfluidic devices and methods of manufacturing patterned microfluidic devices, for example, for biomolecular analysis, and in particular, gene sequencing.

### 2. Technical Background

Biological samples can be complicated in composition and amount. Analysis of biomolecules in a biological sample can involve partitioning a single sample into tens of thousands or millions of samples for quantitative determination, for example, using a solid substrate surface to selectively immobilize and partition different biomolecules in the biological sample.

Microfluidic devices can be used in biomolecular analysis. For example, optical-detection-based massively parallel gene sequencing (also termed next-generation sequencing or NGS) techniques can include capturing and partitioning millions of short DNA fragments from a genomic DNA sample onto a surface of a microfluidic device such that the DNA fragments are spatially separated from each other. Such capturing and partitioning can facilitate sequencing, for example, by synthesis, ligation, or single-molecule real-time imaging.

### SUMMARY

Disclosed herein are patterned microfluidic devices and methods of manufacturing patterned microfluidic devices.

Disclosed herein is a microfluidic device comprising a first substrate comprising a surface, a flow channel disposed in the first substrate such that a sidewall of the flow channel extends between a floor of the flow channel and the surface, a film disposed on the floor of the flow channel, an array of wells disposed in the film, and a second substrate bonded to the surface of the first substrate, whereby the second substrate at least partially covers the flow channel.

Disclosed herein is a method of manufacturing a microfluidic device, the method comprising depositing a layer of beads onto a first substrate, reducing a size of the beads disposed on the first substrate, depositing a film onto the first substrate subsequent to reducing the size of the beads, whereby the film is deposited onto the first substrate at interstitial regions between the beads, removing the beads from the first substrate to form an array of wells in the film, and bonding a second substrate to the surface of the first substrate to enclose the array of wells in a cavity between the first substrate and the second substrate.

Disclosed herein is a method of manufacturing a microfluidic device, the method comprising depositing a layer of beads onto a floor of a flow channel disposed in a first substrate. A sidewall of the flow channel extends between the floor of the flow channel and a surface of the first substrate. The method comprises reducing a size of the beads disposed on the first substrate, depositing a film onto the first substrate subsequent to reducing the size of the beads, whereby the film is deposited onto the floor of the flow channel of the first substrate at interstitial regions between the beads, removing the beads from the first substrate to form an array of wells in the film, and bonding a second substrate to the surface of the first substrate to enclose the array of wells in a cavity between the first substrate and the second substrate.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic top view of some embodiments of a microfluidic device.

FIG. 2 is a schematic cross-sectional view of the microfluidic device taken along line 2-2 of FIG. 1.

FIG. 3 is an atomic force microscope image of some embodiments of a film and an array of wells disposed in the film.

FIG. 4 is a scanning electron microscopic image of some embodiments of a film, an array of wells disposed in the film, and marker beads disposed in the film.

FIG. 5 is a schematic cross-sectional view of some embodiments of a microfluidic device.

FIG. 6 is a schematic cross-sectional view of some embodiments of a microfluidic device.

FIG. 7 is a schematic cross-sectional view of some embodiments of a microfluidic device.

FIG. 8 is a schematic illustration of various steps of some embodiments of a method of manufacturing a microfluidic device.

FIG. 9 is a schematic cross-sectional view of some embodiments of beads that can be used for manufacturing a microfluidic device.

FIG. 10 is a schematic cross-sectional view of some embodiments of beads that can be used for manufacturing a microfluidic device.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, the term “formed from” can mean comprises, consists essentially of, or consists of. For example, a component that is formed from a particular material can comprise the particular material, consist essentially of the particular material, or consist of the particular material.

In various embodiments, a method of manufacturing a microfluidic device comprises depositing a layer of beads onto a first substrate, reducing a size of the beads disposed on the first substrate, and depositing a film onto the first substrate subsequent to reducing the size of the beads, whereby the film is deposited onto the first substrate at interstitial regions between the beads, and removing the beads from the first substrate to form an array of wells in the film. In some embodiments, the method comprises bonding a second substrate to the surface of the first substrate to enclose the array of wells in a cavity between the first substrate and the second substrate. In some embodiments, each of the beads comprises a core and a shell at least partially enveloping the core. In some of such embodiments, reducing the size of the beads comprises removing at least a portion of the shell from the beads (e.g., by plasma etching, photolysis, enzymatic digestion, solvolysis, and/or ozonolysis).

The methods described herein can enable efficient formation of an array of wells on a substrate, for example, for use as a patterned substrate for in vitro diagnostics (IVD) applications, such as DNA sequencing. Additionally, or alternatively, in contrast to conventional lithographic or pressing (e.g., nanoimprinting) processes, the methods described herein can be used to form an array of wells on flat or non-flat substrates. For example, the array of wells can be formed within channels (e.g., flow channels) formed in the substrate prior to patterning, thereby enabling the manufacture of patterned microfluidic devices (e.g., flow cells) without expensive and/or time-consuming semiconductor manufacturing processes that can be used to build flow channels around a patterned substrate surface.

In various embodiments, a microfluidic device comprises a first substrate comprising a surface. In some embodiments, a flow channel is disposed in the substrate such that a sidewall of the flow channel extends between a floor of the flow channel and the surface. In some embodiments, a film is disposed on the surface of the substrate and/or on the floor of the flow channel, and an array of wells is disposed in the film. In some embodiments, a second substrate is bonded to the surface of the first substrate, for example, such that the second substrate at least partially covers the flow channel.

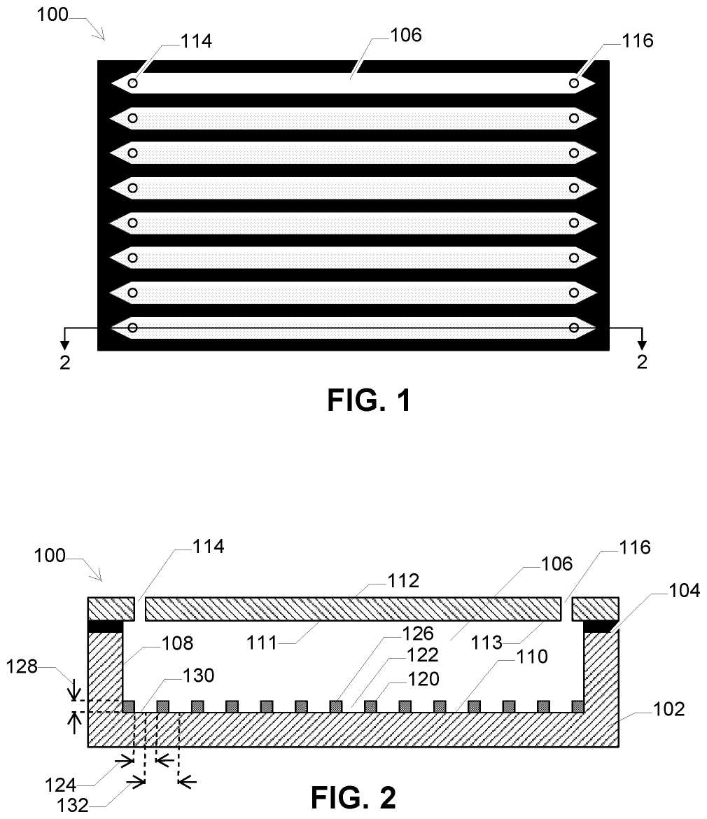

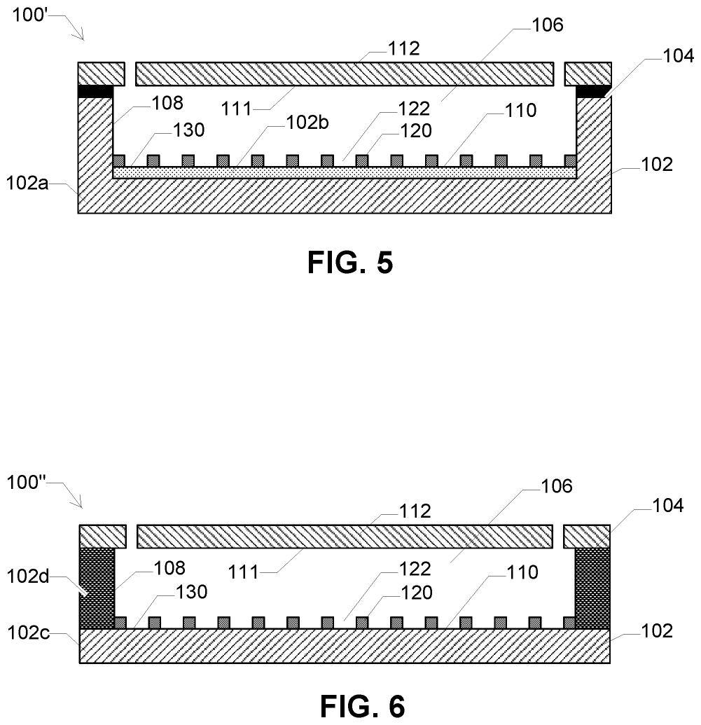

FIG. 1 is a schematic top view of some embodiments of a microfluidic device 100, and FIG. 2 is a schematic cross-sectional view of the microfluidic device taken along line 2-2 of FIG. 1. In some embodiments, microfluidic device 100 comprises a first substrate 102 comprising a surface 104. First substrate 102 can be formed from a glass material, a glass-ceramic material, a metal material, a metal oxide material, a silicon material, a polymeric material, another suitable material, or a combination thereof. In some embodiments, first substrate 100 comprises a monolithic (e.g., single-layer) structure formed from a single material or a homogenous composite of materials (e.g., a monolithic glass substrate as shown in FIG. 2). In other embodiments, first substrate 102 comprises multiple layers formed from different materials (e.g., a glass substrate and a skin disposed on the glass substrate as shown in FIG. 5 and/or a polymeric spacer as shown in FIG. 6).

In some embodiments, a flow channel 106 is disposed in first substrate 102 such that a sidewall 108 of the flow channel extends between a floor 110 of the flow channel and surface 104 of the first substrate. For example, flow channel 106 extends inward into first substrate 102 from surface 104 such that floor 110 of the flow channel is offset from (e.g., disposed beneath) the surface of the first substrate and the flow channel is disposed within the first substrate between the floor and the surface. Flow channel 106 can be formed in first substrate 102 by machining (e.g., mechanical machining and/or photo-machining), etching (e.g., wet chemical etching and/or dry etching), injection molding, another suitable process, or a combination thereof. The choice of approaches used to form channel 106 can depend on the nature of first substrate 102. For example, in some embodiments in which first substrate 102 is formed from a polymeric material, injection molding can be a suitable process. Additionally, or alternatively, in some embodiments in which first substrate 102 is formed from a glass material, wet chemical etching can be a suitable process. Additionally, or alternatively, in some embodiments in which first substrate 102 is formed from silicon and/or a metal material, dry etching can be a suitable process. In some embodiments, microfluidic device 100 comprises a plurality of flow channels 106. For example, microfluidic device 100 comprises eight flow channels as shown in FIG. 1. In various embodiments, the microfluidic device can comprise one, two, three, four, or more flow channels.

In some embodiments, first substrate 102 comprises a monolithic glass substrate as shown in FIG. 2. In some of such embodiments, flow channel 106 can be formed in first substrate 102 by applying a mask to surface 104, leaving a portion of the surface corresponding to the flow channel exposed, and contacting the exposed portion of the surface with an etchant (e.g., an HF-based etchant) to etch the flow channel in the first substrate.

In some embodiments, microfluidic device 100 comprises a second substrate 112 bonded to first substrate 102. For example, second substrate 112 is bonded to surface 104 of first substrate 102, whereby the second substrate at least partially covers flow channel 106. In some embodiments first substrate 102 comprises a monolithic glass substrate as shown in FIG. 2. In some of such embodiments, first substrate 102 defines sidewall 108 and floor 110 of flow channel 106, and second substrate 112 defines a ceiling of the flow channel. In other embodiments, second substrate 112 comprises multiple layers formed from different materials.

Second substrate 112 can be bonded to first substrate 102 by adhesive bonding; laser bonding (or laser welding); anodic bonding; acid- and/or pressure-assisted, low temperature bonding; another suitable bonding technique; or a combination thereof. The bond between first substrate 102 and second substrate 112 can be a fluid-tight and/or hermetic bond, which can help to enable fluid to pass through flow channel 106 (e.g., during use of microfluidic device 100 for IVD applications) without leaking from one flow channel to another or out of the microfluidic device. For example, the bond can be a fluid-tight bond that can withstand fluid pressures typical of IVD applications. In some embodiments, the bond can withstand fluid pressure of at least about 1 pound per square inch (psi), at least 3 psi, and/or at least 5 psi.

In some embodiments, a depth of channel 106 is a distance between floor 110 of the flow channel and a ceiling 111 of the flow channel. For example, ceiling 111 of flow channel 106 can be defined by second substrate 112 (e.g., an interior surface 113 of the second substrate). In some embodiments, the depth of flow channel 110 is about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, or any ranges defined by any of the listed values. For example, the depth of flow channel 110 is about 30 μm to about 500 μm.

In some embodiments, microfluidic device 100 comprises an inlet opening 114 and/or an outlet opening 116. Each of inlet opening 114 and outlet opening 116 can be disposed in or extend through at least one of first substrate 102 or second substrate 112. For example, each of inlet opening 114 and outlet opening 116 extends entirely through at least one of first substrate 102 or second substrate 112 to provide a flow path for fluid to enter and/or exit flow channel 106 from outside microfluidic device 100. In some embodiments, each of inlet opening 114 and outlet opening 116 is disposed in second substrate 112 as shown in FIGS. 1-2. In other embodiments, each of inlet opening 114 and outlet opening 116 is disposed in first substrate 102 or one of the inlet opening or the outlet opening is disposed in the first substrate and the other is disposed in second substrate 112. In some embodiments, outlet opening 116 is disposed opposite inlet opening 114. For example, inlet opening 114 and outlet opening 116 are disposed at opposing longitudinal ends of flow channel 106 such that fluid can be introduced into flow channel 106 through the inlet opening, flow through a length of the flow channel, and exit the flow channel through the outlet opening.

Although flow channel 106 described in reference to FIGS. 1-2 is substantially linear, other embodiments are included in this disclosure. For example, in other embodiments, the flow channel can have a curved shape (e.g., U-shape or C-shape), a V-shape, a zig-zag shape, another suitable shape, or a combination thereof. Additionally, or alternatively, different flow channels can have the same or different shapes.

In some embodiments, microfluidic device 100 comprises a film 120 disposed on first substrate 102. For example, film 120 is disposed on floor 110 of flow channel 106 as shown in FIG. 2. Additionally, or alternatively, film 120 is disposed on surface 104 of first substrate 102. For example, film 120 can be disposed on substantially the entire first substrate 102 (e.g., surface 104 and floor 110) or substantially confined to flow channel 106 (e.g., disposed on the floor, while the surface remains substantially free of the film). Film 120 can be formed from a glass material, a glass-ceramic material, silicon, silicon dioxide, a metal material, a metal oxide material, a polymeric material, another suitable material, or a combination thereof. For example, film 120 is formed from a metal, a metal oxide, or silicon dioxide. Film 120 can be deposited onto first substrate 102 (e.g., surface 104 and/or floor 110) using a suitable deposition process as described herein. For example, film 120 can be deposited onto first substrate 102 by thermal evaporation, electron beam evaporation, sputtering, pulsed laser deposition, another suitable deposition process, or a combination thereof. Additionally, or alternatively, film 120 can be a continuous or substantially continuous layer disposed on first substrate 102 or a discontinuous layer (e.g., interrupted by one or more wells). For example, film 120 can be patterned as described herein.

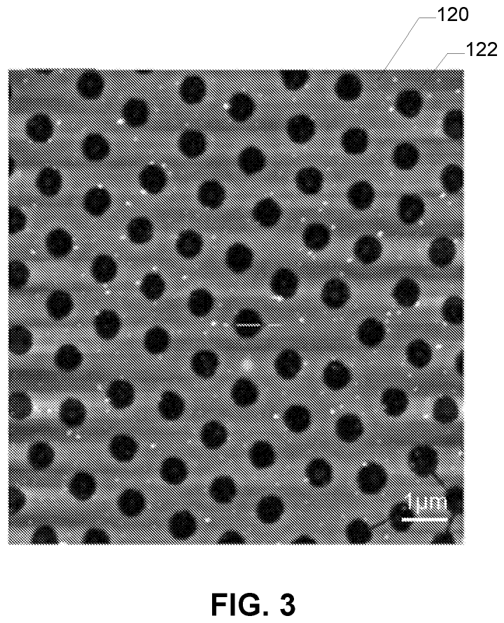

In some embodiments, microfluidic device 100 comprises an array of wells 122 disposed in film 120. FIG. 3 is an atomic force microscope image of some embodiments of film 120 and the array of wells 122 disposed in the film as shown in FIG. 2. Wells 122 can be configured as apertures or depressions in film 120. For example, wells 122 comprise apertures extending entirely through film 120 such that bottom surfaces of the array of wells comprise exposed portions of floor 110 of flow channel 106. Additionally, or alternatively, wells 122 comprise depressions extending partially through film 120 such that bottom surfaces of the array of wells comprise the film (e.g., an interior portion of the film exposed by forming the depressions). The array of wells 122 can be configured as an ordered array (e.g., a hexagonal array) or a non-ordered array (e.g., a random array). The ordered array can be long range (e.g., over a range of greater than about 50 μm) or short range (e.g., over a range of less than about 50 μm). In some embodiments, the array of wells 122 can have both ordered portions and non-ordered portions.

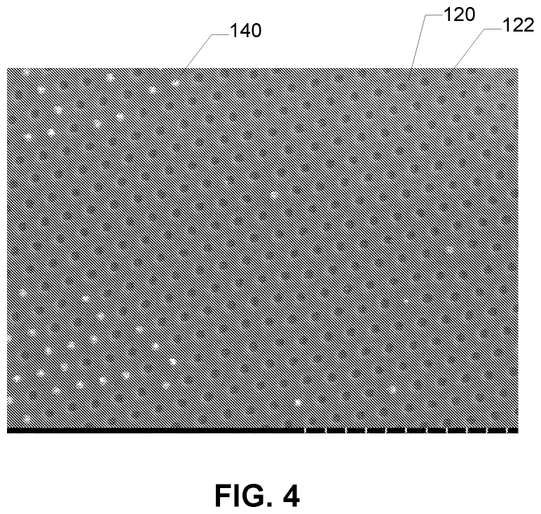

In some embodiments, the array of wells 122 comprise a marker 140. FIG. 4 is a scanning electron microscopic image of some embodiments of microfluidic device 100 comprising a plurality of markers 140 disposed in film 120. For example, markers 140 comprise fluorescent beads disposed in a portion of wells 122. In some embodiments, fluorescent beads can be used as the patterning template, and a portion of the fluorescent beads can be intentionally left on the array of wells 122 by controlling the bead removal process. The fluorescent beads can be used as a fluorescent imaging calibration tool and/or location identification, registration, and/or tracking marker. Additionally, or alternatively, marker 140 comprises a macro-feature (e.g., a line, a square area, a rectangular area, a circular area, a ring structure, or another shaped area that is unpatterned or free of wells). Such macro-feature can be introduced before bead deposition, for example, by printing resist materials or polymeric ink, or by placing a tape having a specific shape. Additionally, or alternatively, marker 140 comprises an array of markers. The marker can be used as a location identifier, or a local registration and/or tracking maker.

Film 120 and the array of wells 122 can define a patterned surface (e.g., a patterned flow channel surface) of microfluidic device 100, which can be beneficial for IVD applications (e.g., DNA sequencing). For example, the array of wells 122 can enable samples of interest (e.g., DNA fragments or oligomers) to be deposited in a relatively high density and/or at defined positions within microfluidic device 100 to enable faster and/or higher quality analysis (e.g., sequencing). The patterned flow channel surface can overcome the limit of Poisson distribution statistics, thereby increasing the number of effective reads for gene sequencing per surface area (e.g., from about 30% Pass Filter (PF) reads for non-patterned surfaces to about 70% PF reads for patterned surfaces).

In some embodiments, a diameter 124 of each well 122 is the largest width of the well, measured at a face 126 of film 120 (e.g., along a plane of the face across the well). Additionally, or alternatively, a depth 128 of each well 122 is the distance between face 126 of film 120 (e.g., the plane of the face) and a bottom surface 130 of the well (e.g., floor 110 of flow channel 106). Additionally, or alternatively, a pitch 132 of the array of wells 122 is the center-to-center distance between adjacent wells. Pitch 132 can be expressed as a pitch between a single pair of wells 122 or as an average pitch over a defined area or a defined number of wells.

In some embodiments, the array of wells 122 comprises a low variability in diameter. For example, the array of wells 122 comprises at most about 20% standard deviation (s.d.), at most about 10%, at most about 5% s.d., at most about 2% s.d., or at most about 1% s.d. of the mean diameter of all wells per area. Additionally, or alternatively, the array of wells 122 comprises a low variability in depth. For example, the array of wells 122 comprises at most about 10% s.d., at most about 5% s.d., at most about 2%, s.d., or at most about 1% s.d. of the mean depth of all wells per area. Additionally, or alternatively, the array of wells 122 comprises a low variability in pitch. For example, the array of wells 122 comprises at most about 10% s.d., at most about 5% s.d., at most about 2% s.d., or at most about 1% s.d. of the mean pitch value. The diameter, depth, and/or pitch can be measured using SEM, AFM, or other suitable technique. The low variability in diameter, depth, and/or pitch can be enabled by the process used to form the array of wells 122 as described herein. For example, the diameter, depth, pitch, and/or ordering of wells can be controlled by controlling the quality of the bead monolayer formed, bead size reduction treatment process parameters, and/or film deposition process parameters. The use of core-shell beads, compared to a single material bead (e.g., silica beads, or polystyrene beads) can beneficially leverage the ability of the core materials of the core-shell beads to act as a stopping mechanism for the bead size reduction treatment, such that the diameter and pitch of wells formed can be precisely controlled as described herein.

In some embodiments, each well 122 of the array of wells has a diameter of about 0.05 μm, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 5 μm, or any ranges defined by any of the listed values. For example, each well 122 of the array of wells has a diameter of about 0.05 μm to about 5 μm. Additionally, or alternatively, an average pitch of adjacent wells 122 of the array of wells is about 0.06 μm, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 2 μm, about 3 μm, about 4 μm, about 6 μm, about 15 μm or any ranges defined by any of the listed values. For example, an average pitch of adjacent wells 122 of the array of wells is about 0.08 μm to about 5 μm. In some embodiments, the pitch is greater than the diameter of wells 122. For example, the pitch is about 1.2×, 1.5×, 1.8×, 2×, or 3× of the average diameter of wells 122.

In some embodiments, the array of wells 122 comprises a hexagonal lattice as shown in FIG. 3. Such a configuration can be a result of the manufacturing process used to form the wells (e.g., the packing of beads as described herein).

In some embodiments, microfluidic device 100 comprises a coating applied to bottom surfaces 130 of wells 122. For example, bottom surfaces 130 of wells 122 comprise a coating of a binding material that enables binding with DNA, proteins, and/or nucleotides. In some embodiments, the binding material comprises at least one of amine-terminated silane, epoxy-terminated silane, carboxylate-terminated silane, thiol-terminated silane, a silane derivative comprising an unsaturated moiety, or a combination thereof. Additionally, or alternatively, the binding material comprises at least one of amine-terminated organophosphate, epoxy-containing organophosphate, carboxylate organophosphate, or a combination thereof. The binding materials can comprise a polymeric material that enables the attachment of DNA, proteins, and/or nucleotides.

FIG. 5 is a schematic cross-sectional view of some embodiments of a microfluidic device 100′. Microfluidic device 100′ is similar to microfluidic device 100 with the exception of the differences described below. Accordingly, a detailed description of the features that are common to microfluidic device 100′ and microfluidic device 100 are not repeated in reference to FIG. 5, and the description of microfluidic device 100 is applicable to microfluidic device 100′.

In some embodiments, microfluidic device 100′ comprises a first substrate 102 comprising multiple layers formed from different materials. For example, first substrate 102 comprises a base substrate 102a and a skin 102b disposed on the base substrate as shown in FIG. 5. Base substrate 102a can be formed from a glass material, a glass-ceramic material, a silicon material, a metal material, a metal oxide material, a polymeric material, another suitable material, or a combination thereof. For example, base substrate 102a can be a monolithic structure as described herein in reference to first substrate 102 of microfluidic device 100. Additionally, or alternatively, skin 102b can be formed from a glass material, a glass-ceramic material, a silicon material, a metal material, a metal oxide material, a polymeric material, another suitable material, or a combination thereof. In some embodiments, base substrate 102a is formed from a glass material, and skin 102b is formed from a metal, a metal oxide, or silicon dioxide.

In some embodiments, flow channel 106 is disposed in first substrate 102 such that sidewall 108 of the flow channel extends between floor 110 of the flow channel and surface 104 of the first substrate. Skin 102b can be disposed on base substrate 102a such that the skin defines floor 110 of flow channel 106 as shown in FIG. 5. For example, skin 102b can be deposited onto base substrate 102a (e.g., as a layer within channel 106 and/or on surface 104) such that the base substrate and the skin cooperatively define first substrate 102. In some embodiments, base substrate 102a comprises a channel formed therein. For example, the channel is formed in base substrate 102a and then skin 102b is deposited in the channel, thereby defining flow channel 106 of microfluidic device 100′. In some embodiments, base substrate 102a defines sidewall 108 of flow channel 106, skin 102b defines floor 110 of the flow channel, and second substrate 112 defines a ceiling of the flow channel. In some embodiments, skin 102b defines surface 104, side wall 108, and floor 110 of the flow channel.

In some embodiments, microfluidic device 100′ comprises film 120 disposed on first substrate 102. For example, film 120 is disposed on floor 110 of flow channel 106 as shown in FIG. 5 and/or on surface 104 of the first substrate. In some embodiments, film 120 is disposed on first substrate 102 such that skin 102b is disposed between base substrate 102a and the film. For example, film 120 is disposed on skin 102b within flow channel 106.

In some embodiments, microfluidic device 100′ comprises the array of wells 122 disposed in film 120. Wells 122 can be configured as apertures or depressions in film 120. For example, wells 122 comprise apertures extending entirely through film 120 such that bottom surfaces of the array of wells comprise exposed portions of floor 110 of flow channel 106 (e.g., exposed portions of skin 102b).

Microfluidic device 100′ comprising base substrate 102a and skin 102b can enable a body of the microfluidic device (e.g., sidewalls 108 and/or an exterior structure) to be formed from a different material than bottom surfaces of wells 122. For example, base substrate 102a can be formed from a material that is suitable for forming channels therein, bonding to second substrate 112, and/or providing desired optical characteristics (e.g., high transparency and/or low autofluorescence). Additionally, or alternatively, skin 102b can be formed from a material that is suitable for bonding to samples of interest (e.g., DNA fragments or oligomers) or bonding to a coating material to be applied to bottom surfaces of wells 122.

FIG. 6 is a schematic cross-sectional view of some embodiments of a microfluidic device 100″. Microfluidic device 100″ is similar to microfluidic device 100 and microfluidic device 100′ with the exception of the differences described below. Accordingly, a detailed description of the features that are common to microfluidic device 100″ and microfluidic device 100 and/or microfluidic device 100′ are not repeated in reference to FIG. 6, and the descriptions of microfluidic device 100 and/or microfluidic device 100′ are applicable to microfluidic device 100″.

In some embodiments, microfluidic device 100″ comprises a first substrate 102 comprising multiple layers formed from different materials. For example, first substrate 102 comprises a base substrate 102c and a spacer 102d disposed on the base substrate as shown in FIG. 6. Base substrate 102c can be formed from a glass material, a glass-ceramic material, a silicon material, a metal material, a metal oxide material, a polymeric material, another suitable material, or a combination thereof. Additionally, or alternatively, spacer 102d can be formed from a glass material, a glass-ceramic material, a metal material, a metal oxide material, a polymeric material, another suitable material, or a combination thereof. In some embodiments, base substrate 102c is formed from a glass material, and spacer 102d is formed from a polymeric material. For example, spacer 102d comprises a double-sided tape formed from a polymeric carrier and an adhesive disposed on one or both surfaces of the polymeric carrier.

In some embodiments, flow channel 106 is disposed in first substrate 102 such that sidewall 108 of the flow channel extends between floor 110 of the flow channel and surface 104 of the first substrate. Spacer 102d can be disposed on base substrate 102c such that the spacer defines sidewall 108 of flow channel 106 as shown in FIG. 6. For example, spacer 102d can be deposited or applied onto base substrate 102c such that the base substrate and the spacer cooperatively define first substrate 102. Flow channel 106 can be formed in first substrate 102 by removing a portion of spacer 102d before or after applying the spacer to base substrate 102c. In some embodiments, base substrate 102c comprises a substantially flat substrate. For example, spacer 102d is deposited onto base substrate 102c to form flow channel 110. In some embodiments, spacer 102d defines sidewall 108 of flow channel 106, base substrate 102c defines floor 110 of the flow channel, and second substrate 112 defines a ceiling of the flow channel.

In some embodiments, microfluidic device 100″ comprises film 120 disposed on first substrate 102. For example, film 120 is disposed on floor 110 of flow channel 106 as shown in FIG. 6.

In some embodiments, microfluidic device 100″ comprises the array of wells 122 disposed in film 120. Wells 122 can be configured as apertures or depressions in film 120. For example, wells 122 comprise apertures extending entirely through film 120 such that bottom surfaces of the array of wells comprise exposed portions of floor 110 of flow channel 106 (e.g., exposed portions of base substrate 102c).

Microfluidic device 100″ comprising base substrate 102c and spacer 102d can enable an alternative manufacturing process for assembling the microfluidic device. For example, depositing film 120 and forming the array of wells 122 can be performed on a relatively flat surface of base substrate 102c, followed by bonding spacer 102d and second substrate 112 to base substrate 102c using an adhesive. Thus, the patterning can be performed on a flat surface, as opposed to being performed within channels. In some embodiments, spacer 102d can be placed on base substrate 102c first, followed by forming the array of wells 122. When bonding with second substrate 112 (e.g., when using spacer 102d or a portion thereof as a bonding material), the spacer can be activated by irradiation or coating with an adhesive material.

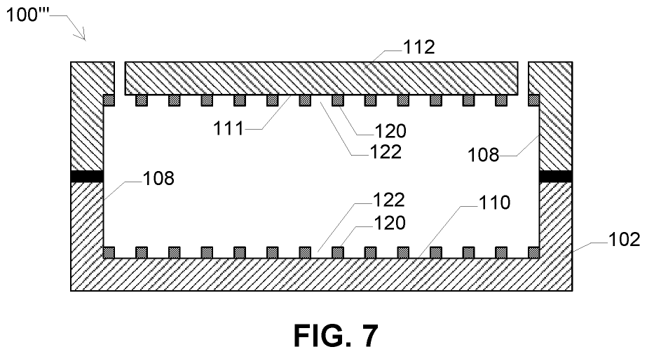

FIG. 7 is a schematic cross-sectional view of some embodiments of a microfluidic device 100″. Microfluidic device 100′″ is similar to microfluidic device 100, microfluidic device 100′, and microfluidic device 100″ with the exception of the differences described below. Accordingly, a detailed description of the features that are common to microfluidic device 100, microfluidic device 100′, and/or microfluidic device 100″ are not repeated in reference to FIG. 7, and the descriptions of microfluidic device 100, microfluidic device 100′, and/or microfluidic device 100″ are applicable to microfluidic device 100′″.

In some embodiments, each of first substrate 102 and second substrate 112 of microfluidic device 100′″ comprises a channel formed therein, and the channels of the first substrate and the second substrate cooperatively form flow channel 106 of the microfluidic device as shown in FIG. 7. For example, each of first substrate 102 and second substrate 112 can be configured as described in reference to first substrate 102 of microfluidic device 100, microfluidic device 100′, and/or microfluidic device 100″. First substrate 102 and second substrate 112 can have substantially the same configuration or different configurations. For example, in some embodiments, each of first substrate 102 and second substrate 112 can be configured as described in reference to first substrate 102 of microfluidic device 100 as shown in FIG. 7. In other embodiments, one of first substrate 102 or second substrate 112 can be configured as described in reference to first substrate 102 of one of microfluidic device 100, microfluidic device 100′, or microfluidic device 100″; and the other of first substrate 102 or second substrate 112 can be configured as described in reference to first substrate 102 of a different one of microfluidic device 100, microfluidic device 100′, or microfluidic device 100″. In some embodiments, first substrate 102 and second substrate 112 cooperatively define sidewall 108 of flow channel 106, the first substrate defines floor 110 of the flow channel, and the second substrate defines ceiling 111 of the flow channel.

In some embodiments, microfluidic device 100′″ comprises film 120 disposed on first substrate 102 and/or second substrate 112. For example, film 120 is disposed on floor 110 and ceiling 111 of flow channel 106 as shown in FIG. 7.

In some embodiments, microfluidic device 100′″ comprises the array of wells 122 disposed in film 120. Wells 122 can be configured as apertures or depressions in film 120. For example, wells 122 comprise apertures extending entirely through film 120 such that bottom surfaces of the array of wells comprise exposed portions of floor 110 or ceiling 111 of flow channel 106 (e.g., exposed portions of first substrate 102 and/or second substrate 112).

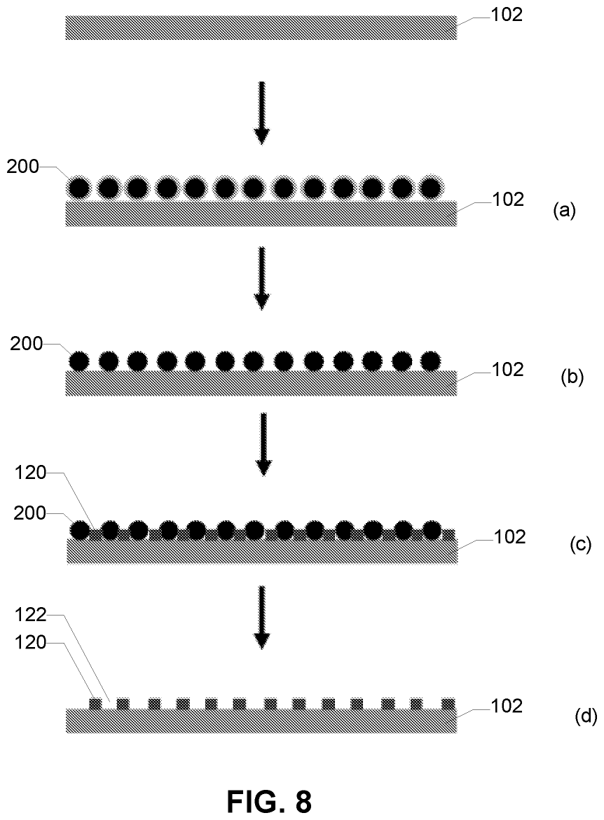

FIG. 8 is a schematic illustration of various steps of some embodiments of a method of manufacturing a microfluidic device (e.g., microfluidic device 100, microfluidic device 100′, microfluidic device 100″, and/or microfluidic device 100′″). For example, the methods described herein can be used to form the patterned surface of the microfluidic device (e.g., the patterned surface disposed on the floor of the flow channel for IVD applications). In some embodiments, the method comprises depositing a layer of beads 200 onto first substrate 102 at step (a). The layer of beads 200 can comprise a monolayer configuration as shown in FIG. 8, a double-layer configuration, or another suitable configuration. Additionally, or alternatively, the layer of beads 200 can be deposited onto first substrate 102 by spin coating, dip coating, a Langmuir-Blodgett process, which may be modified as described herein, another suitable process, or a combination thereof. In some embodiments, depositing the layer of beads 200 onto first substrate 102 comprises depositing the layer of beads onto floor 110 of flow channel 106 disposed in the first substrate. Thus, in contrast to conventional photolithography and imprint lithography processes, the methods described herein can enable patterning within a flow channel or on a structured surface.

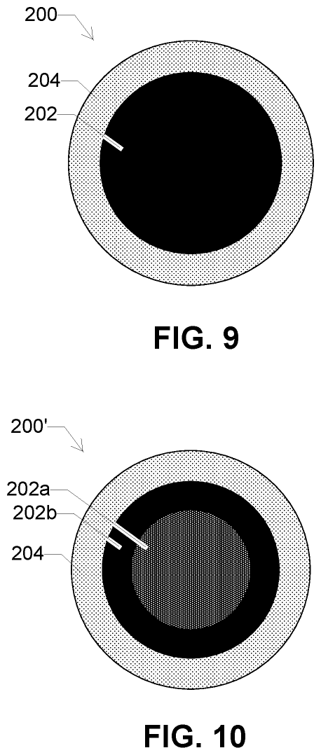

FIG. 9 is a schematic cross-sectional view of some embodiments of beads 200. In some embodiments, each of beads 200 comprises a core 202 and a shell 204 at least partially enveloping the core. Shell 204 can comprise a degradable or dissolvable material as described herein. Additionally, or alternatively, core 202 can comprise a non-degradable or non-dissolvable material as described herein. In some embodiments, shell 204 comprises a degradable material, and core 202 comprises a non-degradable material. Such a configuration can enable selective removal of shell 204 from bead 200, leaving core 202 uncovered and substantially unchanged as described herein.

In some embodiments, shell 204 is formed from a degradable or dissolvable material. For example, shell 204 is formed from a polymer. In some embodiments, the polymer comprises at least one of polystyrene, poly(styrene-co-divinylbenzene), poly(methyl methacrylate), polyacrylic, polygalacturonic acid, or a combination thereof. In some embodiments, core 202 is formed from a non-degradable or non-dissolvable material. For example, core 202 is formed from at least one of a glass, a glass-ceramic, a silica, a metal, a metal oxide, or a combination thereof.

FIG. 10 is a schematic cross-sectional view of some embodiments of beads 200′. Beads 200′ are similar to beads 200 with the exception of the differences described below. Accordingly, a detailed description of the features that are common to beads 200 and beads 200′ are not repeated in reference to FIG. 10, and the description of beads 200 is applicable to beads 200′. In some embodiments, each of beads 200′ comprises core 202 and shell 204 at least partially enveloping the core. In some of such embodiments, core 202 comprises an inner core 202a and an outer core 202b substantially enveloping the inner core such that the outer core is disposed between the inner core and shell 204. Outer core 202b can comprise a non-degradable or non-dissolvable material. Inner core 202a can comprise a non-degradable or non-dissolvable material, or the inner core can comprise a degradable or dissolvable material. For example, outer core 202b can protect inner core 202a during removal of shell 204 from bead 200′, so the inner core may or may not be resistant to the material or process used to remove the shell. In some embodiments, inner core 202a can be omitted such that outer core 202b comprises a hollow structure.

In some embodiments, beads 200 comprise a magnetic material (e.g., ferrite or iron oxide). For example, core 202 (e.g., inner core 202a and/or outer core 202b) is formed from the magnetic material. In some embodiments, inner core 202a is formed from polystyrene, outer core 202b is formed from ferrite or iron oxide, and shell 204 is formed from polystyrene. In some embodiments, depositing the layer of beads 200 onto first substrate 102 comprises exposing the beads to a magnetic field. For example, exposing beads 200 comprising the magnetic material to the magnetic field can help to arrange the beads (e.g., into the monolayer or double-layer configuration) and/or attract the beads toward first substrate 102.

In some embodiments, depositing the layer of beads 200 onto first substrate 102 comprises applying a charge (e.g., an electrostatic charge) to the beads, and applying an opposing charge to the first substrate. For example, the charged beads 200 and/or first substrate 102 can help to arrange the beads (e.g., into the monolayer or double-layer configuration) and/or attract the beads toward the first substrate. The charged beads 200 can provide additional force to enable long-range ordering of beads when deposited onto first substrate 102. Additionally, or alternatively, the charged beads 200 and/or first substrate 102 can help to improve the efficiency and/or quality of bead packing using spin or dip coating (e.g., by taking advantage of electrostatic interaction between the beads and the first substrate).

In some embodiments, the layer of beads 200 disposed on first substrate 102 comprises a hexagonal-close-packed configuration. Such a configuration can be the result of, for example, the process used to deposit the layer of beads 200 on first substrate 102. In some embodiments, the layer of beads 200 disposed on first substrate 102 comprises a hexagonal non-close-packed configuration (e.g., as a result of spin coating conditions). In some embodiments, the layer of beads 200 comprises a random configuration.

In some embodiments, depositing the layer of beads 200 onto first substrate 102 comprises a modified Langmuir-Blodgett process. For example, depositing the layer of beads 200 comprises positioning first substrate 102 on a frame disposed within a container comprising a water drain pipe below the frame. Water can be added to the container until first substrate 102 is submerged in the water. A monolayer of beads 200 can be formed in the container at the water-air interface. For example, a solution comprising beads 200 and an organic solvent can be dispensed into the water bath (e.g., using an automated and controlled syringe pump) until the bead monolayer is formed at the water-air interface. The water can be drained using the water drain pipe to transfer bead 200 monolayer to first substrate 102.

In some embodiments, the method comprises reducing a size of beads 200 disposed on first substrate 102 at step (b) as shown in FIG. 8. For example, reducing the size of beads 200 comprises shrinking the beads to form and/or enlarge interstitial spaces disposed between adjacent beads. In some embodiments, reducing the size of beads 200 comprises reducing the diameter of the beads.

In some of such embodiments, reducing the size of beads 200 comprises removing at least a portion of shell 204 from the beads. For example, removing at least a portion of shell 204 comprises at least one of subjecting beads 200 to at least one of plasma etching, photolysis, enzymatic digestion, solvolysis, ozonolysis, or a combination thereof without substantially changing a size of core 202. For example, in some embodiments in which beads 200 comprise core 202 and shell 204, reducing the size of the beads comprises removing substantially all or at least a portion of the shell from the beads. Such removal of shell 204 can be done without substantially changing a size and/or shape of core 202. For example, beads 200 can be contacted with a material that degrades or dissolves shell 204 without substantially degrading or dissolving core 202. Thus, shell 204 can be selectively removed from core 202, thereby reducing the size of beads 200. Such selective removal of shell 204 can enable a precise reduction in size of beads 200. For example, once the diameter of beads 200 has been reduced by twice the thickness of shell 204 (e.g., by removal of the shell), the removal can cease automatically (e.g., because core 202 is not degradable or dissolvable). Such precise reduction in the size of beads 200 can enable precise (or low variability in) diameter, depth, and/or pitch of the array of wells 122 as described herein. For example, the pitch of the array of wells 122 can be determined at least in part by the size (e.g., diameter) of beads 200 prior to reducing the size of the beads. Additionally, or alternatively, the diameter of the wells 122 and/or the depth of the wells can be determined at least in part by the thickness of shell 204 of beads 200 prior to reducing the size of the beads.

In some embodiments, reactive plasma ashing or etching can be used to remove shell 204 of beads 200 (e.g., in embodiments in which the shell is formed from a polymer or a biopolymer). Additionally, or alternatively, photolysis (e.g., electromagnetic waves with the energy of visible light or higher, such as ultraviolet light, X-rays, or gamma rays) can be used to remove shell 204 of beads 200. Additionally, or alternatively, an enzymatic process (e.g., using an enzyme that is capable of digesting shell 204) can be used to remove the shell of beads 200 (e.g., in embodiments in which the shell is formed from a biodegradable biopolymer such as polygalacturonic acid). Additionally, or alternatively, solvolysis (e.g., hydrolysis, using an acid or a base as a catalyst), can be used to remove shell 204 of beads 200 (e.g., in embodiments in which the shell is formed from a step-growth polymer such as polyesters, polyamides, or polycarbonates). Additionally, or alternatively, ozonolysis and/or oxidation (e.g., under dry conditions) can be used to remove shell 204 of beads 200.

In some embodiments, the method comprises depositing film 120 onto first substrate 102 subsequent to reducing the size of beads 200 at step (c), whereby the film is deposited onto the first substrate at interstitial regions between the beads. Thus, beads 200 serve as a mask to control deposition of film 120 onto first substrate 102. The pattern of film 120 deposited on first substrate 102 can correspond to the interstitial regions between adjacent beads 200, which can be determined by the configuration of the layer of beads disposed on the first substrate and the reduction in size of the beads as described herein.

In some embodiments, depositing film 120 onto first substrate 102 comprises depositing the film onto beads 200 and onto floor 110 of flow channel 106 of the first substrate at interstitial regions between the beads. For example, the layer of beads 200 can be disposed on floor 110 of flow channel 106 as described herein such that film 120 can be deposited onto the floor of the flow channel, which can enable forming a patterned surface on the floor of the flow channel as described herein.

In some embodiments, the method comprises removing beads 200 from first substrate 102 to form the array of wells 122 in film 120 at step (d). For example, beads 200 can be removed using sonication in a solvent solution such as water, ethanol, or other solvents. Additionally, or alternatively, beads 200 can be removed using chemical or enzymatic digestion or degradation (e.g., HF etching to remove silica core, or in embodiments in which the beads are made of a degradable or biodegradable polymer such as polygalacturonic acid (PGA)).

In some embodiments, at least a portion of beads 200 comprise fluorescent beads (e.g., fluorescent polystyrene beads). In some of such embodiments, removing beads 200 from first substrate 102 comprises leaving a portion of the beads (e.g., all or a portion of the fluorescent beads) on the first substrate (e.g., within a portion of wells 122) by controlling the bead removal process. The fluorescent beads 200 left on first substrate 102 can be used for fluorescent imaging calibration and/or location identification, registration, and/or tracking. For example, fluorescent silica beads or rare earth metal doped glass beads can be used as the core of the core-shell beads.

In some embodiments, the method comprises bonding second substrate 112 to surface 104 of first substrate 102 to enclose the array of wells 122 in a cavity (e.g., flow channel 106) between the first substrate and the second substrate. For example, second substrate 112 can be bonded to first substrate 102 by adhesive bonding; laser bonding (or laser welding); anodic bonding; acid- and/or pressure-assisted, low temperature bonding; another suitable bonding technique; or a combination thereof.

It will be apparent to those skilled in the art that various modifications and variations can be made without departing from the spirit or scope of the claimed subject matter. Accordingly, the claimed subject matter is not to be restricted except in light of the attached claims and their equivalents.

1. A microfluidic device comprising:
a first substrate comprising a surface;
a flow channel disposed in the first substrate such that a sidewall of the flow channel extends between a floor of the flow channel and the surface;
a film disposed on the floor of the flow channel;
an array of wells disposed in the film; and
a second substrate bonded to the surface of the first substrate, whereby the second substrate at least partially covers the flow channel;
wherein the array of wells comprises at least one of (i) a low variability in diameter of at most about 20% standard deviation of a mean diameter of all wells per area, (ii) a low variability in depth of at most about 10% standard deviation of a mean depth of all wells per area, or (iii) a low variability in pitch of at most about 20% standard deviation of a mean pitch.

2. The microfluidic device of claim 1, wherein the array of wells comprises each of (i) the low variability in diameter of at most about 20% standard deviation of the mean diameter of all wells per area, (ii) the low variability in depth of at most about 10% standard deviation of the mean depth of all wells per area, and (iii) the low variability in pitch of at most about 20% standard deviation of the mean pitch.

3-10. (canceled)

11. The microfluidic device of claim 1, wherein bottom surfaces of the array of wells comprise exposed portions of the floor of the flow channel.

12. The microfluidic device of claim 11, wherein:
the first substrate comprises a glass substrate;
the film is disposed on the glass substrate; and
the exposed portions of the floor of the flow channel comprise glass.

13. The microfluidic device of claim 11, wherein:
the first substrate comprises a glass substrate and a skin disposed on the glass substrate;
the film is disposed on the skin;
the exposed portions of the floor of the flow channel comprise the skin; and
the skin comprises at least one of a metal, a metal oxide, silicon, or silicon dioxide.

14-24. (canceled)

25. A method of manufacturing a microfluidic device, the method comprising:
depositing a layer of beads onto a first substrate;
reducing a size of the beads disposed on the first substrate;
depositing a film onto the first substrate subsequent to reducing the size of the beads, whereby the film is deposited onto the first substrate at interstitial regions between the beads;
removing the beads from the first substrate to form an array of wells in the film; and
bonding a second substrate to the surface of the first substrate to enclose the array of wells in a cavity between the first substrate and the second substrate.

26. The method of claim 25, wherein:
each of the beads comprises a core and a shell at least partially enveloping the core; and
the reducing the size of the beads comprises removing at least a portion of the shell from the beads.

27. The method of claim 26, wherein the removing at least a portion of the shell comprises at least one of subjecting the beads to at least one of plasma etching, photolysis, enzymatic digestion, solvolysis, ozonolysis, or a combination thereof without substantially changing a size of the core.

28. The method of claim 26, wherein the shell comprises polymer.

29. The method of claim 28, wherein the polymer comprises at least one of polystyrene, poly(styrene-co-divinylbenzene), poly(methyl methacrylate), polyacrylic, polygalacturonic acid, or a combination thereof.

30. The method of claim 26, wherein the core comprises at least one of a glass, a glass-ceramic, silica, a metal, a metal oxide, or a combination thereof.

31. The method of claim 26, wherein the core comprises an inner core and an outer core substantially enveloping the inner core such that the outer core is disposed between the inner core and the shell.

32. The method of claim 25, wherein:
the depositing the layer of beads onto the first substrate comprises depositing the layer of beads onto a floor of a flow channel disposed in the first substrate, a sidewall of the flow channel extending between the floor of the flow channel and a surface of the first substrate; and
the depositing the film onto the first substrate comprises depositing the film onto the beads and onto the floor of the flow channel of the first substrate at interstitial regions between the beads.

33. The method of claim 25, wherein:
the beads comprise a magnetic material; and
the depositing the layer of beads onto the first substrate comprises exposing the beads to a magnetic field.

34. The method of claim 25, wherein the layer of beads comprises a hexagonal-close-packed configuration.

35. The method of claim 25, wherein the layer of beads comprises a random configuration.

36. The method of claim 25, wherein the layer of beads comprises a monolayer configuration.

37. The method of claim 25, wherein the layer of beads comprises a double-layer configuration.

38. The method of claim 25, wherein:
a portion of the beads comprise fluorescent beads; and
removing the beads from the first substrate comprises leaving at least a portion of the fluorescent beads on the first substrate.

39. A method of manufacturing a microfluidic device, the method comprising:
depositing a layer of beads onto a floor of a flow channel disposed in a first substrate, a sidewall of the flow channel extending between the floor of the flow channel and a surface of the first substrate;
reducing a size of the beads disposed on the first substrate;
depositing a film onto the first substrate subsequent to reducing the size of the beads, whereby the film is deposited onto the floor of the flow channel of the first substrate at interstitial regions between the beads;
removing the beads from the first substrate to form an array of wells in the film; and
bonding a second substrate to the surface of the first substrate to enclose the array of wells in a cavity between the first substrate and the second substrate.
